(19) United States
(12) Patent Application Publication
(10) Pub. No.: US 2021/0355343 A1
(43) Pub. Date: Nov. 18, 2021

(54) INHERENTLY SELF-DISINFECTING COATING SURFACES AND METHOD FOR MAKING THEREOF

(71) Applicant: North Carolina State University, Raleigh, NC (US)

(72) Inventors: Richard John Spontak, Raleigh, NC (US); Reza Arman Ghiladi, Raleigh, NC (US); Bharadwaja Srimat Tirumala Peddinti, Raleigh, NC (US); Frank Scholle, Raleigh, NC (US)

(21) Appl. No.: 17/317,485

(22) Filed: May 11, 2021

Related U.S. Application Data
(60) Provisional application No. 63/023,507, filed on May 12, 2020.

(51) Int. Cl. C09D 153/00

(52) U.S. Cl. CPC C09D 153/005

(57) ABSTRACT

The disclosure relates to self-disinfecting, stand-alone coating material for surfaces prone to microbial contamination. The coating material is selected from a midblock-sulfonated pentablock copolymer (s-PBC) and a midblock-sulfonated triblock copolymer. The block copolymer has a configuration A-B-A or A-D-B-D-A, with two unsubstituted styrene end blocks A, an interior styrenic polymer block B carrying sulfonyl groups with a degree of sulfonation of at least 15 mol %, and interior blocks D if present being a polymerized 1,3-butadiene or isoprene which is subsequently hydrogenated. In embodiments, the medium containing the microbes in contact with the coating material has a bulk pH of <2.0 for at least 99.9999% of the microbes to be killed within 5 minutes. The coating material can be reactivated by periodic exposure to acidic solutions to bring the bulk pH of the medium containing the microbes to be <2.0.

### CROSS- REFERENCE TO RELATED APPLICATIONS

This application claims priority to U.S. Provisional Patent Application No. 63/023,507 filed on May 12, 2020, the entire contents of which are incorporated by reference herein.

### TECHNICAL FIELD

The disclosure relates to surfaces that are prone to microbial contamination, and coated with a self-disinfecting polymer that can kill microbes upon contact, and method for making.

### BACKGROUND

Drug resistance among infectious pathogens is increasing at an alarming rate around the world, and is generating global concern regarding the future of public healthcare. While many medical treatments based on antibiotics and antivirals target specific chemical functionalities to induce microbiocide, several microbes have evolved and developed resistance mechanisms that can compromise such treatment. Examples of “nightmare” pathogens, or so-called “superbugs,” include methicillin-resistant (MR) Staphylococcus aureus (S. aureus), often referred to as MRSA, vancomycin resistant (VR) Enterococcus faecium (E. faecium) and carbapenem-resistant Acinetobacter baumannii (A. baumannii). The worldwide proliferation of drug-resistant infectious microbes has been further exacerbated by medical misdiagnosis, antibiotic overuse, and poor prevention. A symptom of this growing medical crisis is the increasing propensity of healthcare-associated infections (HAIs) that largely threaten elderly, injury and immune-compromised patients in medical nursing facilities. According to the CDC, about 1.7 million HAI cases are estimated to occur in the US annually, leading to a 5-6% mortality rate. At least 23,000 and 37,000 deaths are attributed to drug-resistant pathogens alone each year in the US and Europe, respectively. It is estimated that by 2050, deaths due to drug-resistant microbes are predicted to outnumber the deaths caused by cancer. In addition to loss of life, HAIs also introduce an enormous financial burden on healthcare.

In the prior art, several microbicidal approaches have been adopted, including disinfecting surfaces by repeated exposure to radiation (e.g., UV light) or a chemical disinfectant (e.g., bleach, hydrogen peroxide or a detergent), which can damage the surface, adversely affect the environment, or introduce additional health concerns. Metals (e.g., Ag or Cu), or metal oxide (e.g., ZnO or TiO₂) nanoparticles, or metal salts have been embedded inside the matrix, or on the surface, of a polymeric substrate to provide antimicrobial properties. However, bacteria can build up resistance to metals over time. There is also a significant environmental impact as nanoscale metal can leach into the environment and contaminate the food chain or directly enter into higher-level organisms at the subcellular level. In the prior art photodynamic inactivation, photosensitive molecules can be introduced into a polymer, and are subsequently excited by non-coherent visible light, in the presence of molecular oxygen to generate singlet oxygen, which is an effective and sustainable microbiocide. However, this approach applies mainly to bacteria and viral applications and can be largely negated by surface abrasion during application.

There is still a need for a method to provide improved and effective antimicrobial surfaces.

### SUMMARY

In one aspect, the disclosure relates to a self-disinfecting coating material. The coating material is exposed to a medium prone to microbial contamination. The coating material comprises a midblock-sulfonated polymer having a configuration A-B-A or A-D-B-D-A, with two para-substituted styrene end blocks A, an interior styrenic polymer block B carrying sulfonyl groups with a degree of sulfonation of at least 15 mol %. Interior blocks D if present is a polymerized 1,3-butadiene or isoprene which is subsequently hydrogenated. The coating material is periodically reactivated for the medium prone to microbial contamination to have a bulk pH of less than 2.0, or <1.80, or <1.50. The self-disinfecting coating material can be applied to surfaces of biomedical applications, smart textiles, separation membranes, commodity fixtures, and food packaging.

In another aspect, the disclosure relates to a method for disinfecting surfaces exposed to a medium prone to microbial contamination for an extended period of time. The method comprises: applying onto surfaces a coating layer comprising a midblock-sulfonated polymer has a configuration A-B-A or A-D-B-D-A, with two para-substituted styrene end blocks A, an interior styrenic polymer block B carrying sulfonyl groups with a degree of sulfonation of at least 15 mol %, and interior blocks D if present being a polymerized 1,3-butadiene or isoprene which is subsequently hydrogenated; and periodically reactivating the coating layer for the medium prone to microbial contamination to have a bulk pH of less than 2.0.

### BRIEF DESCRIPTION OF THE DRAWINGS

FIG. 1 illustrates the % survival of Vero cell as a function of exposure time, demonstrating that TESET materials are capable of killing Vero cells over the course of just a few minutes

### DESCRIPTION

The following terms used the specification have the following meanings:

“Microbes” refers to microorganisms including bacteria, archaea, fungi (yeasts and molds), algae, protozoa, and viruses, with microscopic size.

“Bulk pH” refers to the pH of the bulk medium, e.g., reflecting the free acid in the multiblock polymers diffusing through the medium (e.g., water) exposed to the microbes, reflecting the pH of the suspension medium for the microbes.

“Ion Exchange Capacity” or IEC refers to the total active sites or functional groups responsible for ion exchange in a polymer. Generally, a conventional acid-base titration method is used to determine the IEC, see for example International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which the weight of the polymer required to provide 1 mole of exchangeable protons.

The disclosure relates to the use of mechanically robust anionic materials produced by selective hydration of midblock-sulfonated multiblock polymers for a surprisingly effective alternative to antimicrobial surfaces.

Multiblock Polymers: The polymer for use in the antimicrobial surfaces is a self-organizing amphiphilic material, comprising a midblock-sulfonated pentablock copolymer (s-PBC) or a midblock-sulfonated triblock copolymer.

In embodiments, the midblock-sulfonated polymer has a configuration A-D-B-D-A (pentablock) or structure A-B-A (triblock), with two para-substituted styrene end blocks A that are resistant to sulfonation, an interior styrenic polymer block B carrying sulfonate groups, and interior blocks D if present for pentablock, being a polymerized 1,3-butadiene or isoprene which is subsequently hydrogenated.

An example of a pentablock is a poly[tert-butylstyrene-b-(ethylene-alt-propylene)-b-(styrenesulfonate)-b-(ethylene-alt-propylene)-b-tert-butylstyrene] (TESET) polymer, with a degree of sulfonation of at least 10 mol %, or at least 25 mol %, or from 26 to 52 mol %, commercially available from Kraton Corporation.

An example of a midblock-sulfonated triblock copolymer is a poly(p-tert-butylstyrene-b-styrenesulfonate-b-p-tert-butylstyrene). Poly(p-tert-butylstyrene-b-styrene-b-p-tert-butylstyrene) (TST) triblock copolymer is synthesized by living anionic polymerization initiated by sec-butyllithium in cyclohexane at 25-30° C., with the midblock being selectively sulfonated to at least 15 mol. %, e.g., ranging from 17 to 63 mol %. as disclosed in J. Polym. Sci. Part B: Polym. Phys., 2017, 55, 490-497, “Molecular and morphological characterization of midblock-sulfonated styrenic triblock copolymers,” by K. P. Mineart et al., incorporated herein by reference in its entirety. An example of a triblock copolymer is as disclosed in U.S. Pat. No. 8,222,346, incorporated herein by reference.

In embodiments, the polymer can self-assemble into a nanostructured substrate due to thermodynamic incompatibility between the contiguous sequences. This network-forming material can be chemically templated by solvent casting, and subsequently annealed in solvent vapor to alter or refine the as-cast morphology, as disclosed in Macromolecules, 2016, 49, 3126-37, “A solvent-vapor approach towards the control of block ionomer morphologies,” by K. P. Mineart et al., incorporated herein by reference in its entirety.

Due to the presence of sulfonic acid groups along the styrenic midblock, the aqueous medium in microbes and/or their suspension simultaneously promotes polymer hydration and reduces the pH of the microbial suspension. The sulfonated midblocks of the polymer allow for considerable swelling in the presence of liquid water ˜170% at 23° C., but over 1000% at 70° C., e.g., for a TESET film with 52% sulfonation cast from tetrahydrofuran THF. The nanostructured polymer behaves as an anionic, reversible (physical) hydrogel in which swollen midblocks are connected to glassy nanodomains that effectively serve as semi-permanent cross-links. The sulfonic acid groups on the polymers lower the pH of the microbial suspension, thus allowing for rapid and dramatic microbial inactivation.

In embodiments, the polymer has a degree of sulfonation of at least 10%, or at least 25%, e.g., 26%, or up to 100%, for the polymer to achieve reliable antimicrobial properties with negligible flow-induced complications during polymer swelling. The ability or availability of the sulfonic acid group to induce a strongly acidic environment of the medium, e.g., with a bulk pH below 2.0, or between 1.5 to 2.0, or down to as low as 0.8, makes the polymer suitable for use against bacteria and viruses.

In embodiments, the polymer has an ion exchange capacity (IEC) of >0.5 meq/g, or >0.75 meq/g, or >1.0 meq/g, or >1.5 meq/g, or >2.0 meq/g, or >2.5 meq/g, or <5.0 meq/g.

Self-Disinfecting Capability: It has been studied and shown that pH has an effect on bacteria, with bacteria being classified according to their preferred pH range: acidophiles (1.0-5.5), neutrophils (5.5-8.0), and alkalophiles (>8.0). Although bacteria can thrive in environments differing in pH, they tend to maintain a neural interior irrespective of the external pH. A sudden change in pH, however, promotes stress on the outer membrane and destroys the membrane, resulting in enzyme damage, protein denaturation and microbe death.

In embodiments, the mid-block sulfonated block copolymer works effectively in destroying/inactivating at least 99%, or at least 99.5%, or at least 99.9%, or at least 95%, or at least 90% of microbes within 120 minutes, 60 minutes, 30 minutes of exposure, or within 5 minutes of exposure, for microbes including but not limited to SARS-CoV-2 virus, MRSA, X-MulV, PI-3, vancomycin-resistant Enterococcus faecium, carbapenem-resistant Acinetobacter baumannii, and influenza A virus.

The sulfonated polymer remains effective in killing microbes even after 4 hours, or after 12 hours, or at least 24 hours, or at least 48 hours. In embodiments, the sulfonated polymer remains effective in killing microbes for at least 3 months, or for at least 6 months.

The mid-block sulfonated block copolymer effectively inactivates both Gram-positive and −negative bacteria. In embodiments, the polymer at higher sulfonation level (e.g., over 50%) is significantly more effective in killing bacteria such as methicillin-susceptible S. aureus as well as MRSA over the same exposure time of 5 minutes than the polymer at lower sulfonation level (e.g., 26%). In embodiments for Gram-negative bacteria, e.g., A. baumannii, Klebsiella pneumonia, and E. coli, the TESET polymer inactivates over 99.9999% at both levels of 26% and 52% sulfonation.

In embodiments, the more highly sulfonated TESET polymer (e.g., 52%) is shown to be more effective than the lower level of sulfonation (26%) after 3 minutes, and with 99.9999% inactivation (i.e., no colony formation observed) in just 5 minutes.

In embodiments, TST polymers with sulfonation level of 40% or above, e.g., samples of TST40 (40% midblock sulfonation) and TST63 (63% midblock sulfonation) polymers, reduce bacterial population of S. aureus after just 5 minutes to the MDL which is defined to be the minimum measured concentration of a substance that can be reported with 99% confidence. For a TST polymer with a sulfonation level of less than 20%, e.g., 17%, the inactivation level of S. aureus after 60 minutes is 99.96%.

Reactivation: In embodiments, the self-disinfecting capability of the polymer can be reduced over time as the polymer is exposed to microbes, e.g., with complexation of the sulfonic acid groups present along the midblock of the polymer. The polymer can be recharged or reactivated to restore its self-disinfecting ability by relatively short immersion in mildly or strongly acidic solutions. The time before reactivation depends on the degree of sulfonation of the midblock, the degree of neutralization, and the acid strength.

In embodiments, the polymer surface can be reactivated upon exposure to acid solutions, with the rejuvenation times time varying inversely with acid strength: 5 min at 1.0 M, 15 min at 0.1 M and 30 min at 0.01 M solution.

Applications: The polymers are suitable for use as coating material that can kill microbes on contact, acting as self-disinfecting material, for use in biomedical applications, smart textiles, separation membranes, commodity fixtures, and food packaging. In embodiments, the self-disinfecting polymer are for use in conjunction with environmental objects, e.g., films, fibers and surfaces. In other embodiments, the polymer is used particularly to coat surfaces that are prone to microbial contamination, thereby inactivating/inhibiting microbes on contact and thus acting as a preventive measure.

The application method depends on the nature of the article/surface to be coated, and the application environment (e.g., a hospital, a workshop, etc.). Different application methods with different carriers, e.g., solvents such as cyclohexane, in aromatic hydrocarbons like toluene, in alcohols like methanol, ethanol, propanol, benzyl alcohol and the like, in various carbonyl solvents like methylethylketone, acetone, and the like. In embodiments, mixtures of solvents can be used as long as homogeneous solutions or stable suspensions can be made.

In embodiments, the polymer can be applied on articles in the form of sheets, films, patterns, and the like, forming a peel-and-stick film.

In embodiments and depending on the final application for antimicrobial effect, the polymer is applied for a protective coating layer of >1 μm, or >5 μm, or >10 μm, or <500 μm, or <200 μm, or <100 μm, or <1000 μm, for a self-sterilizing surface.

In embodiments, the sulfonated polymer is applied in a peel-and-stick form, as a film for adhering to surface (electrostatically or adhesively) for the applications described above. In one example, the sulfonated polymer is applied as a releasable thin layer onto surfaces of frequently touched surfaces.

Examples: The following examples are intended to be non-limiting.

In the examples, the pH measurements of the medium (or the solution) were performed in triplicate with a Mettler Toledo FiveEasy Plus FP20 pH probe calibrated with respect to standard buffer solution.

Example 1—Culturing of bacteria: Methicillin-susceptible S. aureus (ATCC-2913) was cultured in antibiotic-free tryptic soy broth, while MRSA (ATCC-44) was grown in tryptic soy broth containing 5 μg/mL tetracycline. Vancomycin-resistant E. faecium (ATCC-2320) was cultured in the presence of 50 μg/mL ampicillin in DB Difco Bacto Brain Heart Infusion 237500. E. coli BL21-(Dϵ3)pLysS (Stratagene, San Diego, Calif.) and A. baumannii (ATCC-19606) were both grown in Miller LB media with 100 μg/mL ampicillin and without antibiotics, respectively. K. pneumoniae (ATCC-2146) was cultured in DB Difco Nutrient broth #234000 containing 100 μg/mL ampicillin. Each strain was grown in 5 mL of broth in a culture tube incubated at 37° C. and 250 rpm. All strains were grown to an optical density (OD600) of ˜0.4, which corresponded to 1−4×108 CFU/mL (where CFU refers to the number of colony-forming units). After centrifuging the broth at 3600 rpm for 5 min, the supernatant was removed, and the resultant bacterial cell pellet was re-suspended in phosphate buffer saline (PBS) solution.

Example 2: The following midblock-sulfonated pentablock copolymer films commercially available from Kraton Polymers were used:

TABLE 1

| Grade | Degree of mid-block sulfonation |
|---|---|
| TESET52 | 52% |
| TESET39 | 39% |
| TESET26 | 26% |

2 g of the film was dissolved in 40 mL of toluene/isopropanol (TIPA) (80/20 ratio, v/v) or tetrahydrofuran (THF). The mixture was stirred for a period of 30 min for complete polymer dissolution, and the contents were transferred to a Teflon casting bowl. The solvent was allowed to evaporate over 24 hrs. Resultant films produced measured about 250-300 μm. The films were washed several times with distilled water and allowed to dry (the TIPA films) or oven-dried at 40° C. (the THF films) to remove traces of solvent, if any.

Example 2: The example was carried out to study the antibacterial inactivation activities of the mid-block sulfonated films under ambient conditions. Compound free control was taken as reference to calculate the % survival of bacteria. 200 μl of bacterial solution was pipetted out from stock that was previously re-suspended in phosphate buffered saline (PBS) solution and put on top of the film samples. After constant exposure time of 5 minutes (unless otherwise noted), 40 μl of the bacterial solution from the top of the samples was drawn and added to an aliquot containing 360 μl of PBS solution. In some cases, the exposure time was systematically varied. Statistical significance was assessed using an unpaired Student's two-tailed t-test.

Dilutions and plating were performed as in an antimicrobial photodynamic inactivation (aPDI) study. aPDI refers to the use of non-toxic dyes excited with visible light to produce reactive oxygen species (ROS) that can destroy all classes of microorganisms including bacteria, fungi, parasites, and viruses.

The results of the aPDI study show that TESET52 (52% degree of sulfonation) in THF against Gram-positive S. aureus has 99.9999% inactivation rate. TESET52 in THF obtained similar inactivation of 99.9999% against Gram-negative E. coli. With respect to TESET39 and TESET26 against S. aureus, they also showed 99.9999% inactivation, indicating that 26% sulfonation was sufficient to kill S. aureus.

Example 3. For some of the experiments, to eliminate the possibility of inactivation of S. aureus by solvent, 0.1% (v/v) THF and 1% (v/v) THF were directly mixed with the bacterial solution and plated in addition to compound-free control. THF was found not to have any appreciable effect on growth of S. aureus, with TESET52 still achieving 99.9999% inactivation.

Example 4. Previous studies have shown that photo sensitizers (PS) such as zinc meso-tetrakis(N-methylpyridyl) porphyrin (ZnTMPyP(4+)) have shown good effects in killing antibiotic-resistant bacteria. For some experiments, the sulfonated block polymer material was used with conjunction with ZnTMPyP(4+) to take advantage of the ionic interactions between the polymer and the photo sensitizers to achieve better dispersion. However, results have shown that the material has the ability to kill bacteria up on contact on its own, even with 26% sulfonation (i.e., TESET26) for S. aureus.

Example 5. The example is to study the antiviral effect of the midblock sulfonated polymer films. In this example against Vesicular stomatitis virus (VSV), polymer films were prepared in the same fashion as in the antibacterial tests, and a similar control was used as a reference to calculate the level of viral inactivation. All the tests were performed in at least triplicate unless otherwise noted. After exposing 25 μL of VSV suspension to the TESET polymers for 5 min, 100 μL of minimum essential medium (MEM) composed of 1% fetal bovine serum (FBS), 10 mM 4-(2-hydroxyethyl)-1-piperazineethanesulfonic acid (HEPES) and antibiotics were added to remove adhered VSV from the polymer films. The viruses were subsequently titered after serial dilution (6 log units) using Vero mammalian cells (epithelial cells from the kidney of the African green monkey) that were incubated in a 24-well plate under isothermal conditions at 37° C. The concentration of VSV was determined by plaque assay in which crystal violet was used to stain infected Vero mammalian cells after infecting them for 24 h. The level of VSV inactivation was determined by counting the number of plaques, and the MDL was 66.7 PFU/mL. After 5 min exposure, the TESET polymers reduced the VSV count below the MDL.

Example 6. In this example Human adenovirus-5 (HAd-5) was tested. The procedure is similar to that of VSV. After an exposure time of 5 min on the TESET26 and TESET52 polymers, 100 μL of Dulbecco's Modified Eagle's medium (DMEM) containing 10% FBS and antibiotics were added to remove adhered HAd-5 from the films. The viruses were titered as above using A549 cells (from a human lung carcinoma cell line) in 24-well plates at 37° C. The A549 cells were infected for 120 h, after which time infected cells were stained with crystal violet. The level of HAd-5 inactivation was determined by counting the number of plaques, and the MDL was 66.7 PFU/mL. The TESET52 polymer inactivated 99.997% of the virus population.

Example 7. This example is to test against Influenza A virus. The procedure is similar to that of VSV and HAd-5. After an exposure time of 5 min on the TESET26 and TESET52 polymers, DMEM with 0.2% bovine serum albumin (BSA), 25 mM HEPES buffer, antibiotics, and 2 μg/mL TPCK (tosyl phenylalanyl chloromethyl ketone)-treated trypsin were used to remove adhered Influenza A viruses from the films. The viruses were titered as above using Madine-Darby canine kidney cells (MDCK), and the cells were infected for 48 h prior to staining with crystal violet. The level of Influenza A inactivation was determined by counting the number of plaques, and the MDL was 66.7 PFU/mL After 5 min exposure, the TESET polymers reduced the VSV count below the MDL.

Without being bound to any theory, it is believed that there are two possible mechanisms by which the polymer inactivates the microbes. Firstly, sulfonic acid groups being strong oxidizing groups, can oxidize components of cell-wall compromising its integrity. Secondly, the sulfonic acid groups could be binding with the cations such as Ca²⁺, Zn²⁺, Mg²⁺, Na⁺, K⁺ that either bind the peptidoglycan to non-peptidoglycan part of the cell to maintain its structural integrity or facilitate transport across membrane, leading to cell death.

Example 8. The example is to illustrate the worst case scenario wherein the self-disinfecting ability is progressively compromised as the polymer undergoes cyclic exposure to PBS, and the extent to which the sulfonic acid groups can be reactivated (and the antimicrobial performance rejuvenated). It is believed that repeated exposure to pathogens suspended in PBS can result in a reduction in antimicrobial efficacy due to complexation of the sulfonic acid groups present along the midblock of the multiblock polymer and cations from PBS. Although in practice, cations such as these will most likely not be present at high concentrations, if at all, as pathogens come in contact with the polymer surface.

TESET52 material was exposed to 10 successive cycles of S. aureus in PBS, after which time, the surface was nearly completely deactivated (with a high bacterial survival of 87%). These specimens have been subsequently subjected to immersion in aqueous HCl solutions at different concentrations (0.01, 0.1 and 1.0 M) for different times, and their antimicrobial performance has been re-measured. Results show that even after deleterious complexation with cationic species from PBS, these charged multiblock polymers can be fully reactivated (to yield low S. aureus survival at the MDL) after relatively short rejuvenation times, varying inversely with acid strength: 5 min at 1.0 M, 15 min at 0.1 M and 30 min at 0.01 M. It should be noted that the acidity of the 0.01 M HCl (aq) solution is comparable to that of either white distilled vinegar (pH≈2.5) or lemon juice (pH≈2-3).

Example 9: It has been shown that the selectively sulfonated midblock polymers display acute, fast fast-acting anti-microbial properties against several (drug-resistant) bacterial and viral strains. This example is to evaluate the toxicity of the polymers toward mammalian cells, in case the materials come into contact with live cells in contemporary applications such as wound care dressings or transdermal drug delivery.

The toxicity of the TESET26 and TESET52 materials on Vero mammalian cells was monitored by a Trypan Blue exclusion assay. Briefly, Vero cells were grown in 175 cm² flasks to confluency, trypsinized and adjusted to a cell suspension of 4×10⁶ cells/mL. Next, 25 μL of this suspension were added to discs of TESET26 or TESET52 in the bottom of a 96-well plate, and the cells were incubated for different time periods. Wells without TESET served as a negative control. At the end of the incubation, 25 μL of growth medium (Dulbecco's Modified Eagle Medium, supplemented with 6% fetal bovine serum and 1% penicillin/streptomycin) were added, and each cell suspension was transferred to a fresh well. Lastly, 50 μL of Hyclone Trypan Blue solution was added, and the cells were counted in a hemocytometer (Neubauer Improved) at 10× magnification on a Motic AE20 inverted brightfield microscope.

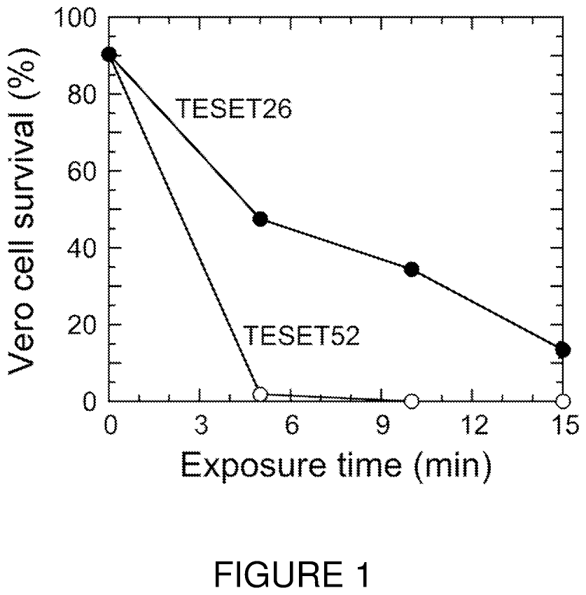

FIG. 1 illustrates the % survival of Vero cell as a function of exposure time, demonstrating that TESET materials are capable of killing Vero cells over the course of just a few minutes. The effectiveness is shown to increase with an increase in the degree of polymer sulfonation, thereby following the same trend observed with respect to antimicrobial performance.

Example 10: In tests evaluation of the long-lasting antiviral properties, film samples of sulfonated penta block copolymer (SPBC) of the structure poly[tert-butylstyrene-b-(ethylene-alt-propylene)-b-(styrene-co-styrene-isulfonate)-b-(ethylene-alt-propylene)-tert-butylstyrene] with 52% sulfonation were cast out of 1:1 mixture of toluene and 1-propanol. The sulfonated polymer film samples were subjected to abrasion testing of 2200 cycles in the presence of 3 common disinfectants: 70% ethanol, benzalkonium chloride, and quaternary ammonia, and exposure to SARS-CoV-2 virus suspension of concentration 10⁷ pfu/ml.

After 2 hours of contact, viable virus was recovered from each sample by washing twice with 500 μl of DMEM tissue culture media containing 10% serum, and measured by serial dilution plaque assay. The results demonstrate that, after abrasion testing representing approximately one year of cleaning (6 disinfectant wipes/day), surface pro Gibco Dulbecco's Modified Eagle Medium (DMEM) is a widely used basal medium for supporting the growth of many different mammalian cells.

Example 11: A multi-layer laminate was formed by casting a sulfonated block polymer solution (sulfonated block polymers in toluene/1-propanol at a 1:1 ratio) onto a Mylar sheet of 1 mil thick.

The casting was done on a mechanical casting table with a casting blade, e.g., Elcometer 4340, controlling the thickness, and the speed of solution being casted on a substrate. A set amount of sulfonated polymer, depending on the desired thickness, was poured onto a substrate. A casting blade was pulled over the liquid, creating a uniform thickness over a substrate. The material was next placed in a chamber where the solvent can be slowly evaporated. After all the solvent was evaporated, the casting was complete forming a laminate structure having thickness ranging from 0.0176″ to 0.0003″.

Surface pH of the antimicrobial layer was measured using a surface pH measuring probe. For the pH test, a small drop of water around 0.02 ml was placed on the antimicrobial layer. The probe was placed on top of the water drop, touching the surface of the layer, and pH was measured after 5 minutes, giving a pH of 2.0.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

Unless otherwise specified, all technical and scientific terms used herein have the same meanings as commonly understood by one of skill in the art to which the disclosed disclosure belongs. The recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A self-disinfecting coating material, the material for coating surfaces prone to microbial contamination, the coating material comprising a midblock-sulfonated polymer having a configuration A-B-A or A-D-B-D-A, with two para-substituted styrene end blocks A, an interior styrenic polymer block B carrying sulfonyl groups with a degree of sulfonation of at least 10 mol %, and interior blocks D if present being a polymerized 1,3-butadiene or isoprene which is subsequently hydrogenated;
wherein the coating material kills at least 90% of the microbes within 5 minutes of contact.

2. The self-disinfecting coating material of claim 1, wherein a medium containing the microbes in contact with the coating material has a bulk pH of less than 2.0.

3. The self-disinfecting coating material of claim 1, for killing at least 99.9999% of the microbes within 5 minutes.

4. The self-disinfecting coating material of claim 1, for killing at least 99% of the microbes within 60 minutes.

5. The self-disinfecting coating material of claim 1, for killing at least 90% of the microbes within 5 minutes, and for an extended duration of time of more than 60 minutes.

6. The self-disinfecting coating material of claim 1, wherein the coating material is for coating surfaces of biomedical applications, smart textiles, separation membranes, commodity fixtures, and food packaging.

7. The self-disinfecting coating material of claim 1, wherein the coating material comprises a midblock sulfonated pentablock polymer having the configuration A-D-B-D-A.

8. The self-disinfecting coating material of claim 1, wherein the coating material comprises a poly[tert-butylstyrene-b-(ethylene-alt-propylene)-b-(styrenesulfonate)-b-(ethylene-alt-propylene)-b-tert-butylstyrene] (TESET) pentablock polymer, with a degree of sulfonation of at least 15 mol %.

9. The self-disinfecting coating material of claim 1, wherein the coating material comprises a midblock sulfonated triblock polymer having a general structure A-B-A, with the A blocks being para-substituted styrene end blocks, and the B block is a polymer block of selectively hydrogenated conjugated diene and sulfonated to at least 15 mol %

10. The self-disinfecting coating material of claim 1, wherein the coating material comprises a poly(p-tert-butylstyrene-b-styrenesulfonate -b-p-tert-butylstyrene) (TST) triblock polymer, synthesized by living anionic polymerization, with the midblock being selectively sulfonated for a degree of sulfonation ranging from 15 to 70 mol %.

11. The self-disinfecting coating material of claim 10, wherein the coating material is periodically reactivated by exposing the midblock-sulfonated polymer to an acidic solution.

12. The self-disinfecting coating material of claim 10, wherein the midblock-sulfonated polymer is periodically reactivated by exposing to an acidic solution having a concentration of at least 1.0M for at least 5 minutes.

13. The self-disinfecting coating material of claim 10, wherein the midblock-sulfonated polymer is reactivated by exposing to an acidic solution having a concentration of at least 0.01M for at least 30 minutes.

14. The self-disinfecting coating material of claim 1, wherein the coating material is applied onto surfaces as a film.

15. The self-disinfecting coating material of claim 1, wherein the coating material kills more than 99.9999% of Gram-positive and −negative bacteria in 5 minutes or less.

16. A method for disinfecting surfaces exposed to a medium prone to microbial contamination for an extended period of time, the method comprising:
applying onto surfaces a coating layer comprising a midblock-sulfonated polymer has a configuration A-B-A or A-D-B-D-A, with two para-substituted styrene end blocks A, an interior styrenic polymer block B carrying sulfonyl groups with a degree of sulfonation of at least 15 mol %, and interior blocks D if present being a polymerized 1,3-butadiene or isoprene which is subsequently hydrogenated; and
periodically reactivating the coating layer for the medium prone to microbial contamination to have a bulk pH of less than 2.0.

17. The method of claim 16, wherein periodically reactivating the coating layer comprises periodically exposing the coating layer to acidic solutions.

18. The method of claim 16, wherein periodically reactivating the coating layer comprises periodically exposing the coating layer to an acidic solution having a concentration of at least 0.01M for at least 30 minutes.

19. The method of claim 16, wherein periodically reactivating the coating layer comprises periodically exposing the coating layer to an acidic solution having a concentration of at least 1.0M for at least 5 minutes.

20. The method of claim 16, wherein the coating layer is applied onto surfaces of biomedical applications, smart textiles, separation membranes, commodity fixtures, and food packaging.

21. The method of claim 16, wherein the coating layer comprises a midblock sulfonated pentablock polymer having the configuration A-D-B-D-A or a midblock sulfonated triblock polymer having a general structure A-B-A.

22. An article having at least a surface coated by the self-disinfecting coating material of claim 1.

23. The self-disinfecting coating material of claim 1, wherein the midblock-sulfonated polymer has an ionic exchange capacity (IEC) of >0.5 meq/g.

24. The self-disinfecting coating material of claim 1, wherein the coating material is applied onto surfaces prone to microbial contamination for a thickness of at least >5 μm, and wherein the coating material kills >95% of microbes within 120 minutes of contact after six months of application onto the surfaces.

25. The self-disinfecting coating material of claim 1, wherein the coating material is applied onto the surfaces as a peel-and-stick film or a laminate.

26. A method to provide protection to a surface prone to microbial contamination, the method comprising applying onto the surface a coating layer comprising the self-disinfecting coating material of claim 1.

27. A self-disinfecting coating material, the material for coating surfaces prone to microbial contamination, the coating material comprising a midblock-sulfonated polymer having a configuration A-B-A or A-D-B-D-A, with two para-substituted styrene end blocks A, an interior styrenic polymer block B carrying sulfonyl groups with a degree of sulfonation of at least 15 mol %, and interior blocks D if present being a polymerized 1,3-butadiene or isoprene which is subsequently hydrogenated;
wherein the coating material kills at least 90% of the microbes within 5 minutes of contact.
